(19) United States
(12) Patent Application Publication
(10) Pub. No.: US 2023/0024977 A1
(43) Pub. Date: Jan. 26, 2023

(54) METHOD OF PROCESSING DATA, DATA PROCESSING DEVICE, DATA PROCESSING PROGRAM, AND METHOD OF GENERATING NEURAL NETWORK MODEL

(71) Applicant: Preferred Networks, Inc., Tokyo (JP)

(72) Inventor: Gentaro WATANABE, Tokyo (JP)

(21) Appl. No.: 17/814,292

(22) Filed: Jul. 22, 2022

(30) Foreign Application Priority Data
Jul. 26, 2021 (JP) 2021-121506

(51) Int. Cl. G06F 3/06; G06N 3/02

(52) U.S. Cl. CPC G06F 3/0608; G06F 3/0638; G06F 3/0679; G06N 3/02

(57) ABSTRACT

A method of processing data related to a machine learning model, executed by a computer including a memory including a memory area and a processor, includes: compressing the data in a course of calculation of a first calculation process, to generate compressed data; storing the generated compressed data in the memory area; and executing a second calculation process by using the compressed data stored in the memory area.

### CROSS-REFERENCE TO RELATED APPLICATIONS

The present application is based upon and claims priority under 35 U.S.C. § 119 to Japanese Patent Application No. 2021-121506 filed on Jul. 26, 2021, the entire contents of which are incorporated herein by reference.

### BACKGROUND

### 1. Field

The present disclosure relates to a method of processing data, a data processing device, a data processing program, and a method of generating a neural network model.

### 2. Description of the Related Art

In general, regarding machine learning, in data processing such as model training, there are cases where intermediate data as an intermediate result of calculation of a forward process is stored in an external memory such as a DRAM (Dynamic Random Access Memory) for a backward process. Then, there are also cases where, from among the intermediate data stored in the external memory, intermediate data required for calculation of the backward process is read from the external memory, to execute the calculation of the backward process.

### SUMMARY

According to an embodiment in the present disclosure, a method of processing data related to a machine learning model, executed by a computer including a processor and a memory including a memory area, includes: compressing the data in a course of calculation of a first calculation process, to generate compressed data; storing the generated compressed data in the memory area; and executing a second calculation process by using the compressed data stored in the memory area.

### BRIEF DESCRIPTION OF DRAWINGS

FIG. 1 is a block diagram illustrating an example of a data processing device according to an embodiment in the present disclosure;

FIG. 2 is an explanatory diagram illustrating an example of training of a neural network executed by the data processing device illustrated in FIG. 1;

FIG. 3 is an explanatory diagram illustrating an example of a forward process in training of a neural network according to the present embodiment;

FIG. 4 is an explanatory diagram illustrating an example of a backward process and an optimization process in training of a neural network according to the present embodiment;

FIG. 5 is an explanatory diagram illustrating an example of a determination table used in a forward process according to the first embodiment;

FIG. 6 is a flow chart illustrating an example of a forward process of a neural network, executed by the data processing device in FIG. 1;

FIG. 7 is an explanatory diagram illustrating an example of a determination table that is used in a forward process of a neural network, executed by a data processing device according to a second embodiment in the present disclosure;

FIG. 8 is a flow chart illustrating an example of a forward process of a neural network, executed by the data processing device according to the second embodiment;

FIG. 9 is a flow chart illustrating a continuation of the forward process in FIG. 8; and

FIG. 10 is a block diagram illustrating an example of a hardware configuration of the data processing device according to the embodiments described above.

### DETAILED DESCRIPTION OF THE EMBODIMENTS

In the following, embodiments in the present disclosure will be described in detail with reference to the accompanying drawings.

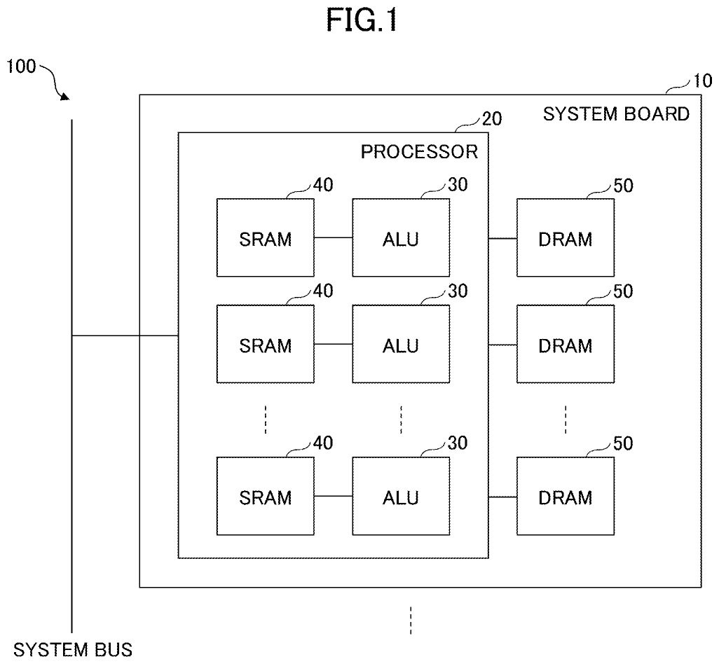

FIG. 1 is a block diagram illustrating an example of a data processing device according to an embodiment in the present disclosure. The data processing device 100 illustrated in FIG. 1 includes at least one system board 10 that includes a processor 20 and multiple DRAMs (Dynamic Random Access Memories) 50 connected to the processor 20. For example, the data processing device 100 may be a server.

The processor 20 includes multiple arithmetic/logic units 30, and multiple SRAMs (Static Random Access Memories) 40 each connected to a corresponding one of the arithmetic/logic units 30. The processor 20 is connected to a system bus. The processor 20 may have a form of a chip or may have a form of a package. The arithmetic/logic unit is an example of an arithmetic/logic processing device.

In the present embodiment, the memory bandwidth of the SRAM 40 is greater than the memory bandwidth of the DRAM 50. Therefore, it is favorable that data used by the processor 20 for calculation is saved in the SRAM 40 if the data can be stored in the SRAM 40. However, in the case where the SRAM 40 is built in the processor 20, there may be a case where it is difficult to save all data used by the processor 20 in the SRAM 40. In this case, data that cannot be saved in the SRAM may be saved in the DRAM 50 that has a smaller memory bandwidth.

Note that an internal memory connected to the arithmetic/logic unit 30 is not limited to the SRAM 40, and may be, for example, a cache memory. An external memory connected to the processor 20 is not limited to the DRAM 50, and may be, for example, an MRAM (Magnetoresistive Random Access Memory), HDD (Hard Disk Drive), SSD (Solid State Drive), or the like. The SRAM 40 is an example of a first memory, and a memory area allocated in the SRAM 40 is an example of a first memory area. The DRAM 50 is an example of a second memory, and a memory area allocated in the DRAM 50 is an example of a second memory area.

In this way, the data processing device 100 according to the present embodiment has multiple types of memories (in the present embodiment, the SRAM 40 and the DRAM 50) having respective memory bandwidths different from each other.

Note that in the case where the SRAM 40 having a sufficient memory capacity can be installed in the processor 20 or the system board 10, the first memory area and the second memory area may be allocated in the SRAM 40.

The data processing device 100 executes multiple calculation processes to execute training of a neural network having multiple layers. One of the calculation processes is, for example, a forward process of the neural network, and another of the calculation processes is a backward process of the neural network. Also, the calculation process executed by the data processing device 100 is not limited to training of the neural network. For example, the data processing device 100 may execute a calculation process of scientific calculation and the like.

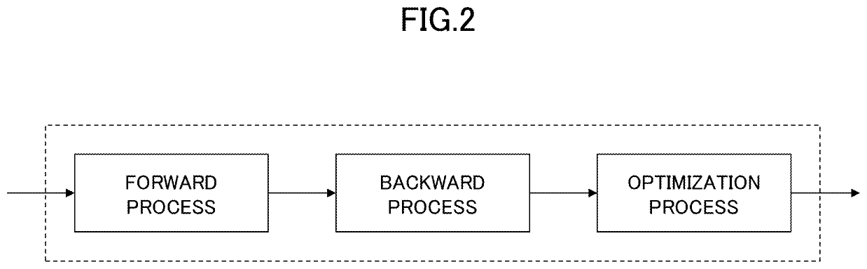

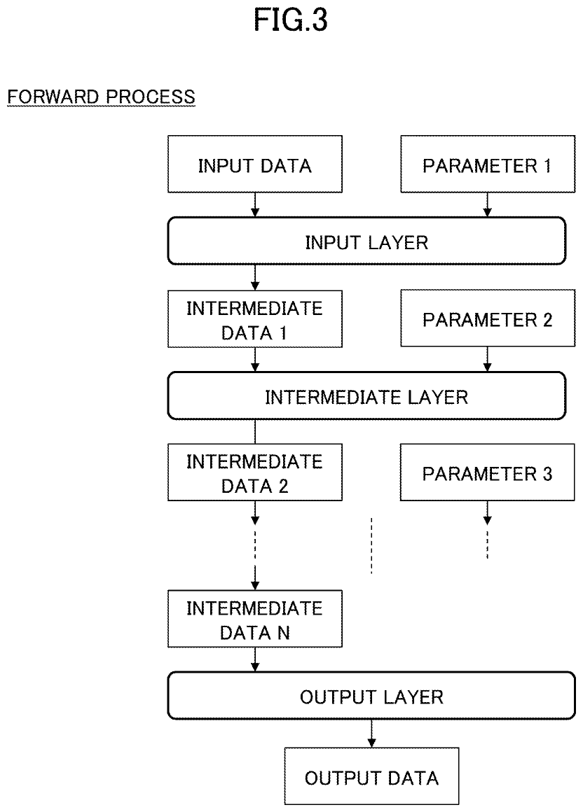

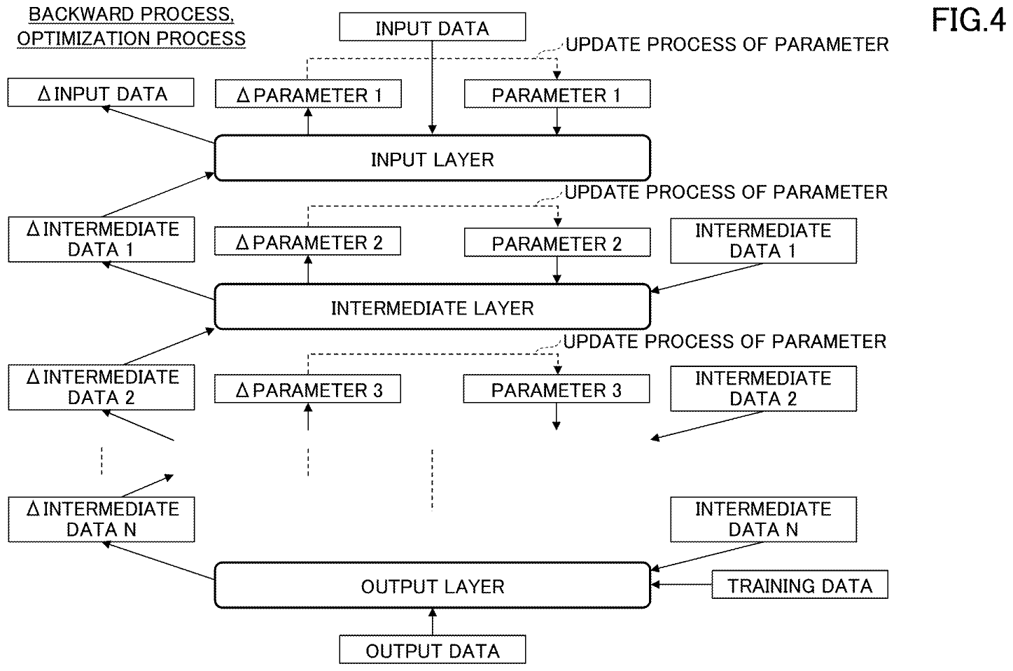

FIG. 2 is an explanatory diagram illustrating an example of training of a neural network executed by the data processing device 100 illustrated in FIG. 1. For example, FIG. 2 illustrates an example of a method of generating a neural network model by machine learning. In machine learning according to the present embodiment, in which a neural network having multiple intermediate layers between an input layer and an output layer is trained, the forward process, the backward process, and an optimization process are repeatedly executed for multiple times while changing training data. Then, the data processing device 100 generates a neural network model based on the training. The forward process, the backward process, and the optimization process will be described with FIGS. 3 and 4. The forward process is an example of a first calculation process, and the backward process is an example of a second calculation process. The forward process, the backward process, and the optimization process are an example of a third calculation process. Note that in the present specification, generation of a model or generation of a neural network includes adjusting the model or parameters of the neural network.

FIG. 3 is an explanatory diagram illustrating an example of the forward process in training of a neural network according to the present embodiment. For example, FIG. 3 illustrates an example of the forward process in the method of generating a neural network model by machine learning. In the forward process, data and parameters such as weights are input into each of the input layer and a predetermined number of intermediate layers. In the input layer, operations are executed with input data and parameters 1, to generate intermediate data 1. In an intermediate layer next to the input layer, operations are executed with the intermediate data 1 and the parameters 1, to generate intermediate data 2.

In subsequent intermediate layers, operations are executed with intermediate data generated by the preceding intermediate layer and parameters set for each of the intermediate layers, and intermediate data generated by the operations is output to the next intermediate layer. Note that there may be an intermediate layer that does not use parameters. As the intermediate layers, there are, for example, a convolution layer, a pooling layer, a fully connected layer, and the like.

In the present embodiment, the intermediate data that is generated in the input layer and the intermediate layers is stored in the SRAM 40 without compression. Then, the intermediate layers and the output layer that execute calculation processes read the uncompressed intermediate data from the SRAM 40, to use the read data in the calculation processes. By using the uncompressed intermediate data in the forward process, the data processing device 100 can execute the forward process while while not reducing the calculation precision. The intermediate data is an example of data in a course of calculation generated with each layer in a calculation process.

The intermediate data is also used in the backward process described with FIG. 4. In the present embodiment, the intermediate data used in the backward process is compressed, and then, stored in the SRAM 40, the DRAM 50, or both of the SRAM 40 and the DRAM 50. In the backward process, by holding the data in the memory after applying compression to the intermediate data, the memory usage can be reduced. Accordingly, without installing a faster DRAM 50, and without expanding the data bus width, a sufficient memory bandwidth between the processor 20 and the DRAM 50 required to store the intermediate data generated by the forward process in the DRAM 50, can be secured. In other words, the memory bandwidth required to store the intermediate data in the DRAM 50 can be reduced compared to the memory bandwidth required to store the entirety of the intermediate data in the DRAM 50. Accordingly, increase in the system cost of the data processing device 100 can be curbed.

For example, the intermediate data used in the backward process may be compressed with lossy compression. Lossy compression has a smaller compression cost than lossless compression, and in some cases, the compression rate can be maintained to be constant; therefore, the load imposed on the processor 20 due to the compression process can be reduced.

Also, in calculation of the backward process that uses the intermediate data obtained in the forward process, an error in the intermediate data has only a local effect, and it is often the case that the error does not propagate and is not accumulated over a wide range. For example, in the backward process of a convolution layer, the intermediate data generated by the forward process affects only the gradient of a weight of the convolution layer.

Also, the value of a gradient calculated by the backward process may not require higher precision than in the forward process. For example, when updating a weight in a stochastic gradient descent method, the value of the gradient is expected to be smaller than the value of the weight; therefore, even in the case where a relative error of the gradient is great, the effect on calculation of the backward process can be kept small. Therefore, also in the case of executing the backward process by using compressed intermediate data, an appropriate weight can be calculated.

The data processing device 100 can execute operations as described above, for example, by using conversion of floating-point number data. Specifically, the data processing device 100 may execute the calculation process in the forward process by using double-precision floating-point number data, and convert the generated intermediate data from double-precision floating-point number data to single-precision floating-point number data, to compress the intermediate data. Also, the data processing device 100 may convert single-precision floating-point number data to 8-bit fixed-point number data, to compress the intermediate data. Accordingly, by using an existing conversion method, lossy compression can be simply applied to the intermediate data. Further, the data processing device 100 may compress the intermediate data by reducing the number of bits (the number of digits) in the mantissa of the floating-point number data.

Note that the compression rate of the intermediate data may be set higher as training of the neural network progresses. In other words, the training of the neural network illustrated in FIG. 2 may be repeatedly executed while gradually increasing the compression rate of the intermediate data. For example, the data processing device 100 may execute calculation in a predetermined number of iterations in the beginning by using single-precision floating-point number data, and execute calculation in a predetermined number of iterations coming next by using half-precision floating-point number data. The data processing device 100 may further execute calculation in the next 100 iterations by using 8-bit fixed-point number data. The predetermined number of iterations may be, for example, 100 or the like.

Also, in the case of using floating-point number data in the forward process, the data processing device 100 may sequentially reduce the number of bits in the mantissa every time the predetermined number of iterations have been executed, to gradually increase the compression rate of the intermediate data. In this way, by gradually increasing the compression rate of the intermediate data, the memory bandwidth for transferring the intermediate data can be further curbed, and the increase in the system cost of the data processing device 100 can be further curbed.

Note that the data processing device 100 may compress multiple items of intermediate data together, instead of compressing the items of intermediate data one by one. In this case, there is a likelihood that the compression rate of the intermediate data becomes higher, which contributes to reduction of the memory bandwidth and reduction of the system cost.

In the output layer, output data is calculated by using the intermediate data N that is generated by the intermediate layer N (the N-th layer) preceding to the output layer. In the output layer that calculates errors in a classification problem, for example, a soft-max function is used as the activation function and cross entropy is used as the error function, to calculate output data (a solution). In the output layer, as described with FIG. 4, the output data is compared with training data (correct data), to calculate an error with respect to a correct answer (loss function).

In this way, in the forward process, in each layer of a neural network, operations are executed with input data and parameters, to calculate data (intermediate data) to be input into the next layer, and output data is output from the last layer (forward propagation). Note that the forward process may be used not only for training of a neural network, but also for inference using a neural network. The forward processes can be represented by a computational graph such as a DAG (Directed Acyclic Graph).

FIG. 4 is an explanatory diagram illustrating an example of the backward process and the optimization process in training of a neural network according to the present embodiment. For example, FIG. 4 illustrates an example of the backward process in the method of generating a neural network model by machine learning. In the backward process, error back propagation to propagate errors in the reverse order of the forward process is executed. In FIG. 4, a symbol A indicates errors in data or errors in parameters. An update process of parameters executed in the optimization process is indicated by a dashed arrow.

First, in the backward process, in a layer in which errors are calculated (the output layer), output data generated by the forward process is compared with training data, and Δintermediate data N is generated, which corresponds to errors with respect to the intermediate data N being input into the output layer. The Δintermediate data N also corresponds to the errors in output data output by the N-th intermediate layer.

Next, in the intermediate layers, starting from an intermediate layer that is closest to the output layer, operations are executed with the errors with respect to the output data (Δintermediate data), and the intermediate data as the input data, to generate Δparameters as the errors with respect to the parameters of the intermediate layer. The Δparameters each indicates the gradient of the parameter on a curve showing change in the error with respect to change in the parameter. For example, in the intermediate layer adjacent to the input layer, operations are executed with the Δintermediate data 2 and the intermediate data 1, to calculate the Δparameters 2.

Also, in each intermediate layer, operations are executed with the errors with respect to the output data (Δintermediate data), and the parameters of the intermediate layer, to generate the Δintermediate data as the errors with respect to the input data of the intermediate layer. The errors with respect to the input data of the intermediate layer (Δintermediate data) also correspond to the errors in the output data of the preceding intermediate layer (or the input layer). For example, in the intermediate layer adjacent to the input layer, operations are executed with the Δintermediate data 2 and the parameter 2, to calculate the Δintermediate data 1. Here, the intermediate data is read, for example, from the SRAM 40 or the DRAM 50 for each layer.

Also in the input layer as in the intermediate layers, operations are executed with the Δintermediate data 1 and the input data, to calculate the Δparameters 1; and operations are executed with the Δintermediate data 1 and the parameters 1, to calculate the Δinput data as the errors with respect to the input data. In this way, in the backward process, intermediate data as an intermediate result of calculation by the forward process is required.

In the optimization process, in each intermediate layer and the input layer, the parameters are corrected by using the Δparameters (gradients of errors) calculated in the backward process. In other words, the parameters are optimized. Optimization of the parameters is executed by using a gradient descent method such as momentum-SGD (Stochastic Gradient Descent) or ADAM.

In this way, in the backward process, errors in data (output data of the intermediate layer preceding to the output layer) input into the output layer are calculated from the output data and the training data. Then, the process of calculating errors in the intermediate data by using the calculated errors in the data, and the process of calculating errors in the parameters by using the errors in the intermediate data, are executed in order from the output layer side (error back propagation). In the update process of the parameters, the parameters are optimized based on the errors in the parameters obtained in the backward process.

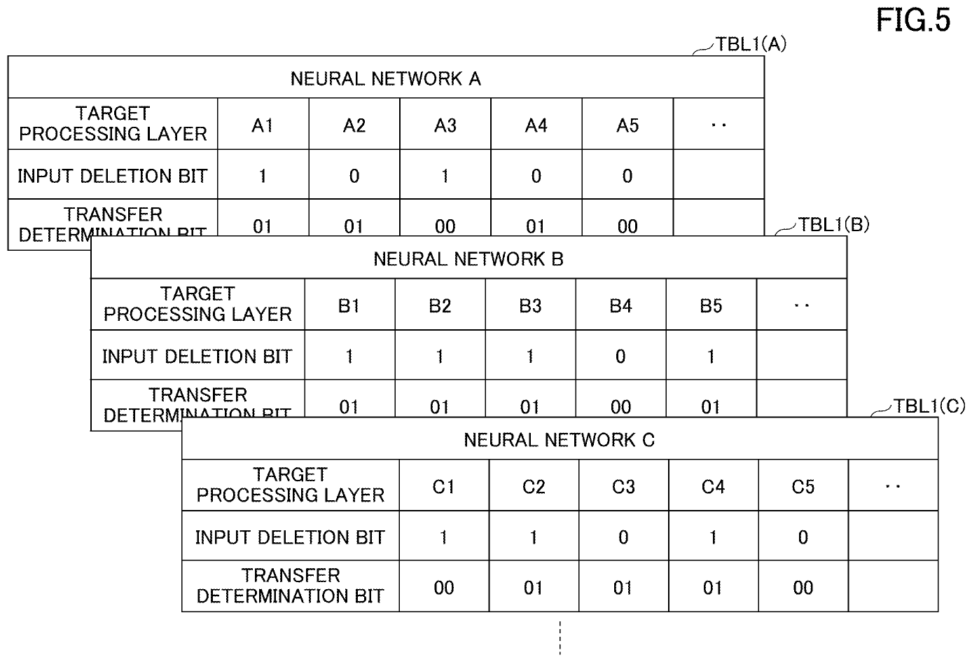

FIG. 5 is an explanatory diagram illustrating an example of a determination table (example of determination information) used in the forward process according to the first embodiment. For example, determination tables TBL1(A), TBL1(B), TBL1(C), and so on illustrated in FIG. 5 may be allocated in a storage area in the processor 20 (e.g., the SRAM 40 or registers in the arithmetic/logic unit 30). In the following, in the case of describing the determination tables TBL1(A), TBL1(B), TBL1(C), and so on non-selectively, these tables are simply referred to as the determination table(s) TBL1. For example, the determination table TBL1 is provided for each of neural networks A, B, C, and so on.

Each of the determination tables TBL1 according to the present embodiment includes, for each target processing layer, an area to store an input deletion bit (one bit) as an example of information indicating whether to delete data, and an area to store transfer determination bits (two bits) as an example of information indicating a forwarding destination. The input deletion bit holds information indicating whether to delete target uncompressed intermediate data input into the target processing layer from the SRAM 40, after the calculation process for the target processing layer has been executed. For example, the input deletion bit being ‘0’ indicates that the target uncompressed intermediate data is not to be deleted from the SRAM 40, whereas the input deletion bit being ‘1’ indicates that the target uncompressed intermediate data is to be deleted from the SRAM 40. The input deletion bit is an example of deletion information indicating whether to delete uncompressed intermediate data from the SRAM 40.

In the case of the input deletion bit being ‘0’, the data processing device 100 according to the present embodiment, after having executed the calculation process for the target processing layer, does not delete and keeps holding the uncompressed intermediate data, which is a result of the calculation process in another layer that was used in the calculation process, from the SRAM 40. Also, in the case of the input deletion bit being ‘1’, the data processing device 100, after having executed the calculation process for the target processing layer, deletes the uncompressed intermediate data, which is a result of the calculation process in another layer that was used in the calculation process, from the SRAM 40.

By deleting the uncompressed intermediate data from the SRAM 40 when the data is no longer needed in the calculation process thereafter, the data processing device 100 according to the present embodiment can curb the memory capacity of the SRAM built in the processor 20. Note that in some cases, the uncompressed intermediate data is used in the calculation process of multiple layers. In this case, only the input deletion bit corresponding to a layer to be executed last is set to ‘1’. Accordingly, in the case where common intermediate data is used in multiple layers, erroneous deletion of the intermediate data from the SRAM 40 can be prevented.

The transfer determination bits according to the present embodiment hold information indicating a forwarding destination (storage destination) of the intermediate data. The transfer determination bits being ‘00’ indicate that the compressed intermediate data is to be transferred to the SRAM 40. The transfer determination bits being ‘01’ indicate that the compressed intermediate data is to be transferred to the DRAM 50. The transfer determination bits being ‘10’ indicate that the compressed intermediate data is to be transferred to the both the SRAM 40 and the DRAM 50. Information held in the transfer determination bits to indicate a forwarding destination(storage destination) of intermediate data is an example of destination information.

By providing the transfer determination bits, the data processing device 100 can easily determine the forwarding destination of the compressed intermediate data for each layer. Note that in the case where the compressed intermediate data is transferred to only one of the SRAM 40 and the DRAM 50, i.e., the compressed intermediate data is not transferred to both of the SRAM 40 and the DRAM 50, the transfer determination bit may be one bit long. In this case, the transfer determination bit being ‘0’ indicates transfer to the SRAM 40, whereas the transfer determination bits being ‘1’ indicates transfer to the DRAM 50.

Note that each of the determination tables TBL1 may have an input deletion bit and transfer determination bits common to all the target processing layers. In other words, the input deletion bit and the transfer determination bits may be set for each neural network. Further, at least one of the determination tables TBL1 may hold multiple input deletion bits and multiple transfer determination bits corresponding to at least one of the target processing layers. In this case, the multiple input deletion bits and the multiple transfer determination bits are set for each of the multiple items of data or multiple data groups that are used in the corresponding target processing layer.

Also, multiple determination tables TBL1 may be provided for multiple compression rates, respectively. For example, in the forward process of the neural network A, in the case where the compression rate is raised sequentially every time a predetermined number of iterations has been executed, determination tables TBL1(A) are provided for the respective compression rates, and a corresponding one of the determination tables TBL1(A) with respect to the number of iterations is referenced. Alternatively, corresponding to each of the determination tables TBL1, a compression rate table (example of compression rate information) may be provided in which correspondence between multiple compression rates and the number of iterations is specified.

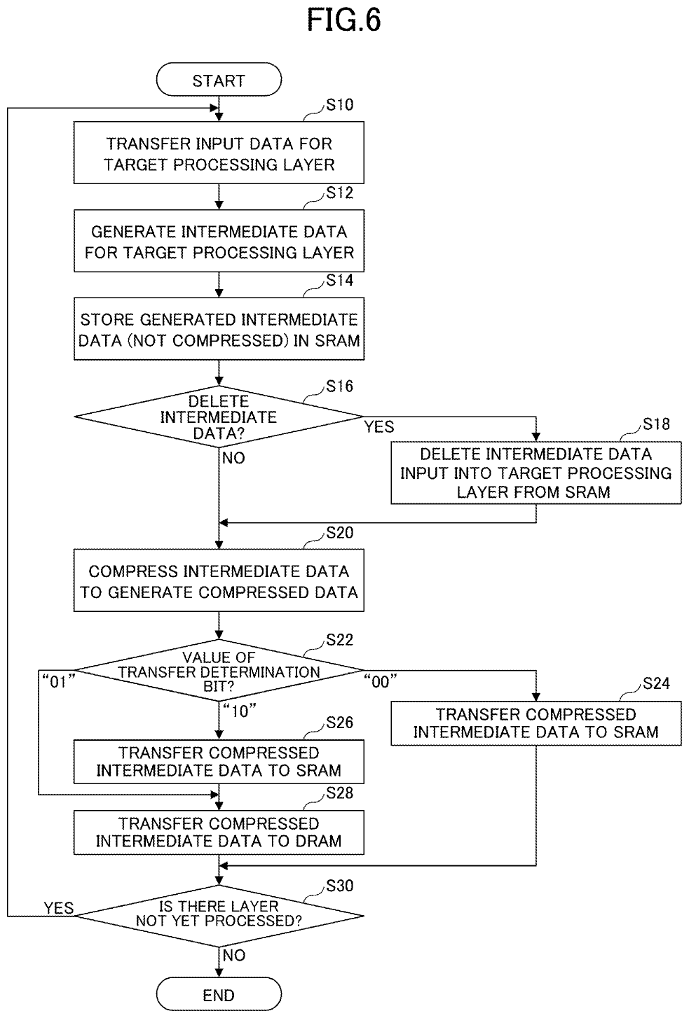

FIG. 6 is a flow chart illustrating an example of the forward process of a neural network executed by the data processing device 100 in FIG. 1. In other words, FIG. 6 illustrates an example of the method of processing data executed by the data processing device 100. For example, the process illustrated in FIG. 6 is implemented by the processor 20 of the data processing device 100 executing a data processing program. For example, FIG. 6 illustrates an example of a forward process in the method of generating a neural network model by machine learning.

First, at Step S10, the processor 20 transfers input data such as parameters or the like that is used in a target processing layer for which the forward process is to be executed, to the SRAM 40. In the input layer illustrated in FIG. 3, the processor 20 transfers the input data 1 and the parameters 1 as the input data to the SRAM 40.

Next, at Step S12, the processor 20 uses the input data transferred at Step S10, to execute the forward process and generate the intermediate data. Next, at Step S14, the processor 20 stores the intermediate data (uncompressed) generated at Step S12 in the SRAM 40.

Next, at Step S16, the processor 20 refers to the input deletion bit of the determination table TBL1, to determine whether to delete the uncompressed intermediate data input into the target processing layer from the SRAM 40. If the input deletion bit is ‘1’, the processor 20 determines to delete the uncompressed intermediate data from the SRAM 40, and causes the process to transition to Step S18. If the input deletion bit is ‘0’, the processor 20 determines not to delete the uncompressed intermediate data from the SRAM 40, and causes the process to transition to Step S20.

At Step S18, the processor 20 deletes the uncompressed intermediate data input into the target processing layer from the SRAM 40, and causes the process to transition to Step S20. At Step S20, the processor 20 compresses the intermediate data calculated by the forward process of the target processing layer, to generate the compressed data.

Next, at Step S22, the processor 20 refers to the transfer determination bits of the determination table TBL1. If the transfer determination bits are ‘00’, the processor 20 determines to transfer the intermediate data to the SRAM 40, and causes the process to transition to Step S24. If the transfer determination bits are ‘01’, the processor 20 determines to transfer the intermediate data to the SRAM 40, and causes the process to transition to Step S28. If the transfer determination bits are “10”, the processor 20 determines to transfer the intermediate data to both of the SRAM 40 and the DRAM 50, and causes the process to transition to Step S26.

At Step S24, the processor 20 transfers the intermediate data compressed at Step S20 to the SRAM 40, and causes the process to transition to Step S30. At Step S26, the processor 20 transfers the intermediate data compressed at Step S20 to the SRAM 40, and causes the process to transition to Step S28.

At Step S28, the processor 20 transfers the intermediate data compressed at Step S20 to the DRAM 50, and causes the process to transition to Step S30. Thus, according to the value of the transfer determination bits, the compressed intermediate data can be transferred to at least one of the SRAM 40 and the DRAM 50.

At Step S30, if there is a layer not yet processed, the processor 20 causes the process to return to Step S10, to execute the forward process for the next target processing layer. If there is no layer not yet processed, i.e., if the forward process of the neural network is completed, the processor 20 ends the operations illustrated in FIG. 6.

As above, in the embodiment described with FIGS. 1 to 6, the memory usage holding the intermediate data generated by the forward process can be reduced. Accordingly, without installing a faster DRAM 50, and without expanding the data bus width, a sufficient memory bandwidth between the processor 20 and the DRAM 50 required to store the intermediate data generated by the forward process in the DRAM 50, can be secured. In other words, the memory bandwidth required to store the intermediate data in the DRAM 50 can be reduced compared to the memory bandwidth required to store the entirety of the intermediate data in the DRAM 50. For example, in the backward process, by holding the intermediate data in the memory after compression, the memory usage can be further reduced, and the memory bandwidth of the memory storing the intermediate data can be further reduced. Accordingly, without dropping the efficiency and the precision of the backward process, increase in the system cost of the data processing device 100 can be curbed.

Note that the first process and the second process in the present specification are not limited to the forward process and the backward process when training a machine learning model.

In the intermediate layer and the output layer that executes the calculation processes, the data processing device 100 reads the intermediate data stored uncompressed in the SRAM 40, and uses the read uncompressed intermediate data in the calculation process. By using the intermediate data being uncompressed data in the forward process, the forward process can be executed while not reducing the calculation precision.

By deleting the uncompressed intermediate data from the SRAM 40 when the data is no longer needed in the calculation process thereafter, the data processing device 100 can curb the memory capacity of the SRAM 40 built in the processor 20. By providing the input deletion bit for each target processing layer, even in the case where common intermediate data is used in multiple layers, erroneous deletion of the intermediate data from a SRAM 40 can be prevented.

By providing the transfer determination bits, the data processing device 100 can easily determine the forwarding destination of the compressed intermediate data for each layer.

By applying lossy compression to the intermediate data to be used in the backward process, the compression cost can be reduced compared to lossless compression, and the compression rate can be kept constant; therefore, the load imposed on the processor 20 due to the compression process can be reduced.

By representing the intermediate data in a floating-point number data format, and compressing the intermediate data by reducing the number of bits in the mantissa (number of digits), lossy compression can be easily applied to the intermediate data.

By setting the compression rate of the intermediate data to become higher as the calculation process of the layer progresses, the memory bandwidth for transferring the intermediate data can be further curbed, and the increase in the system cost of the data processing device 100 can be further curbed.

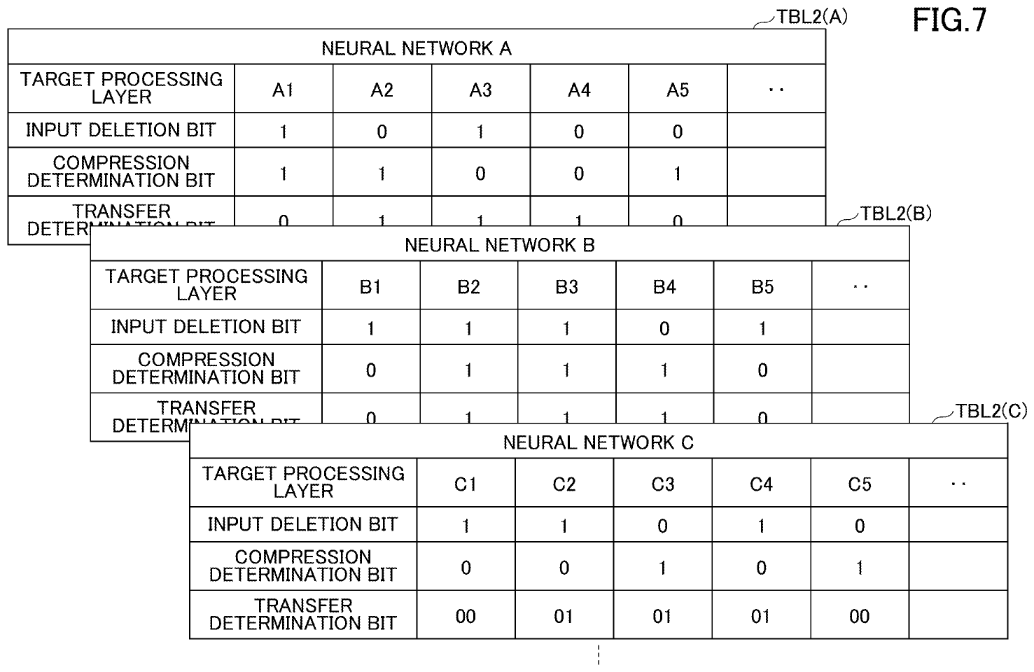

FIG. 7 is an explanatory diagram illustrating an example of a determination table that is used in the forward process of a neural network, executed by a data processing device according to a second embodiment in the present disclosure. For substantially the same elements as in FIG. 5, detailed description will be omitted.

The data processing device that refers to determination tables TBL2(A), TBL2(B), TBL2(C), and so on in FIG. 7 has a configuration that is substantially the same as that of the data processing device 100 illustrated in FIG. 1. In other words, the data processing device of this embodiment includes at least one system board 10 that includes a processor 20 including multiple arithmetic/logic units 30 and multiple SRAMs 40, and DRAMs 50.

In the following, when describing the determination tables TBL2(A), TBL2(B), TBL2(C), and so on non-selectively, these tables are simply referred to as the determination table(s) TBL2. For example, as in the case of the determination table TBL1, the determination table TBL2 is provided for each of neural networks A, B, C, and so on.

The determination table TBL2 includes an area to store a compression determination bit that is added to the determination table TBL1 in FIG. 5. In other words, each determination table TBL2 has an area to store an input deletion bit (one bit), a compression determination bit (one bit), and transfer determination bits (two bits) for each target processing layer.

The compression determination bit being ‘0’ indicates that the intermediate data is to be compressed, whereas the compression determination bit being ‘1’ indicates that the intermediate data is not to be compressed. In other words, in this embodiment, whether to compress the intermediate data can be switched for each target processing layer. For example, in the case where the size of intermediate data to be generated is large, the compression determination bit is set to ‘0’, whereas in the case where the size of intermediate data to be generated is small, the compression determination bit is set to ‘1’. Accordingly, in the case where the size of the intermediate data is large, increase in the memory bandwidth can be curbed, and increase in the system cost of the data processing device can be curbed. On the other hand, in the case where the size of the intermediate data is small, the compression cost can be reduced.

In the case of the compression determination bit being ‘0’, the meaning of each value of the transfer determination bits is the same as the meaning of each value of the transfer determination bits of the determination table TBL1 in FIG. 5. In other words, the transfer determination bits being ‘00’ indicate that the compressed intermediate data is to be transferred to the SRAM 40. The transfer determination bits being ‘01’ indicate that the compressed intermediate data is to be transferred to the DRAM 50. The transfer determination bits being ‘10’ indicate that the compressed intermediate data is to be transferred to the both the SRAM 40 and the DRAM 50.

On the other hand, in the case of the compression determination bit being ‘1’, the meaning of each value in the transfer determination bits is as follows. The transfer determination bits being ‘00’ indicate that the uncompressed intermediate data is to be transferred to the DRAM 50. The transfer determination bits being ‘01’ indicate that uncompressed intermediate data is not to be transferred to the DRAM 50.

The uncompressed intermediate data is always transferred to the SRAM 40. Therefore, in the case of the compression determination bit being ‘1’ and the transfer determination bits being ‘00’, the uncompressed intermediate data is to be transferred to both of the SRAM 40 and the DRAM 50. In the case of the compression determination bit being ‘1’ and the transfer determination bits being ‘01’, the uncompressed intermediate data is to be transferred only to the SRAM 40.

In this embodiment, the meaning of the transfer determination bits varies depending on whether or not the intermediate data is to be compressed according to the compression determination bit. In other words, the transfer determination bits can be shared between the case of compressing the intermediate data and the case of not compressing the intermediate data, and thereby, increase in the size of the determination table TBL2 can be curbed.

Note that as in the embodiment described above, each of the determination tables TBL2 may have an input deletion bit, a compression determination bit, and transfer determination bits that are common to all the target processing layers. In other words, the input deletion bit, the compression determination bit, and the transfer determination bits may be set for each neural network. Further, at least one of the determination tables TBL2 may hold multiple input deletion bits, multiple compression determination bits, and multiple transfer determination bits corresponding to at least one of the target processing layers. In this case, the multiple input deletion bits, the multiple compression determination bits, and the multiple transfer determination bits are set for each of the multiple items of data or multiple data groups that are used in the corresponding target processing layer.

Also, multiple determination tables TBL2 may be provided for multiple compression rates, respectively. For example, in the forward process of the neural network A, in the case where the compression rate is raised sequentially every time a predetermined number of iterations has been executed, determination tables TBL2(A) are provided for the respective compression rates, and a corresponding one of the determination tables TBL2(A) with respect to the number of iterations is referenced. Alternatively, corresponding to each of the determination tables TBL2, a compression rate table may be provided in which correspondence between multiple compression rates and the number of iterations is specified.

Further, in the case where the compressed intermediate data is transferred to only one of the SRAM 40 and the DRAM 50, i.e., the compressed intermediate data is not transferred to both of the SRAM 40 and the DRAM 50, the transfer determination bit may be one bit long. In this case, in the case of the compression determination bit being ‘0’, the transfer determination bit being ‘0’ indicates transfer to the SRAM 40, whereas the transfer determination bits being ‘1’ indicates transfer to the DRAM 50. In the case of the compression determination bit being ‘1’, the transfer determination bits being ‘0’ indicates transfer to the DRAM 50, whereas the transfer determination bits being ‘1’ indicates not to transfer to the DRAM 50.

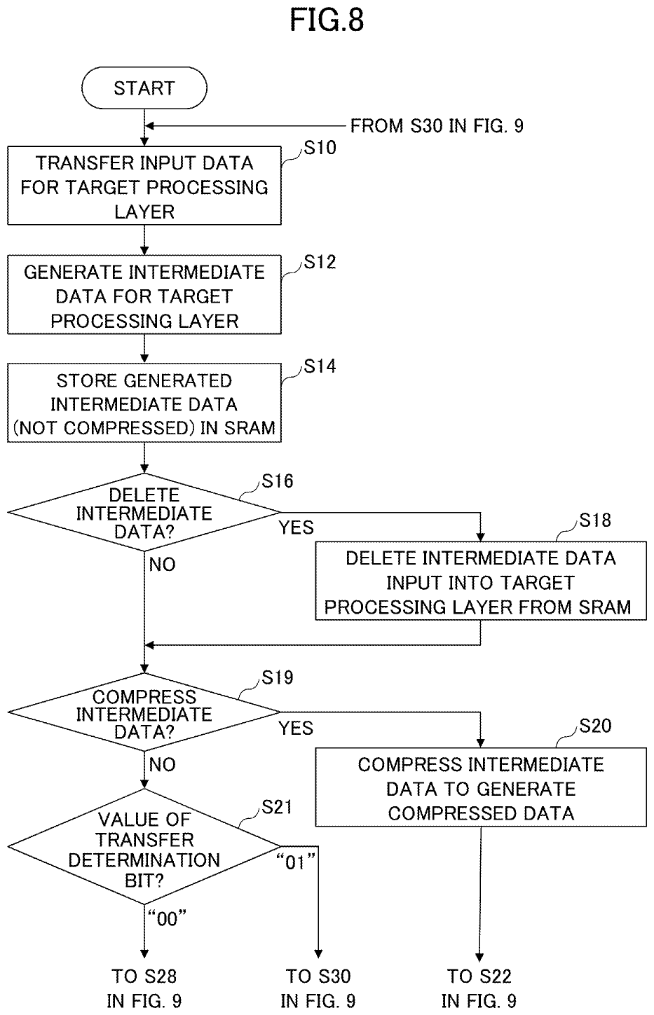

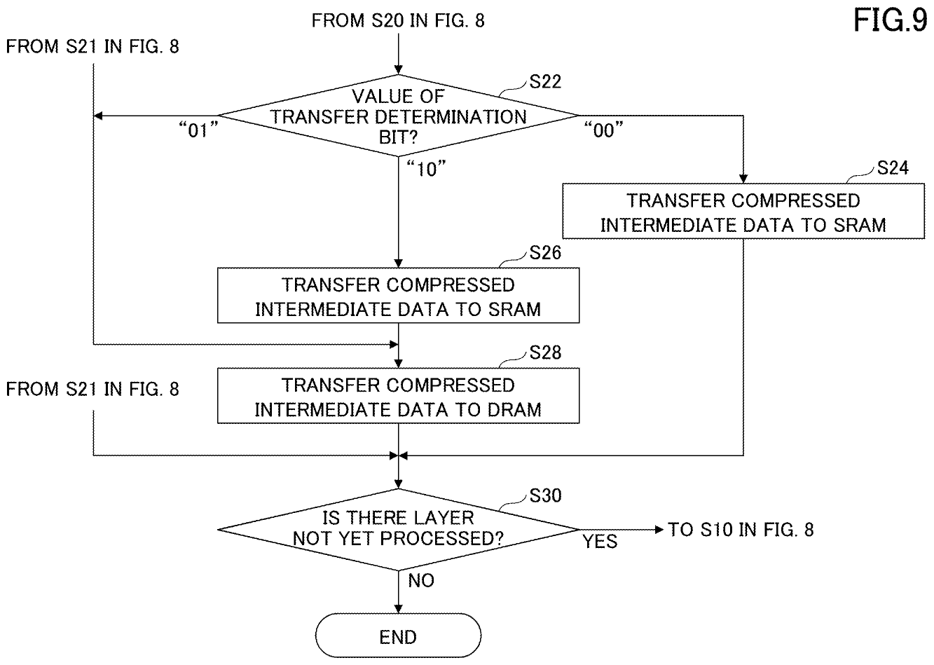

FIGS. 8 and 9 are a flow chart illustrating an example of the forward process of a neural network, executed by the data processing device according to the second embodiment. In other words, FIGS. 8 and 9 illustrate an example of the method of processing data executed by the data processing device. For example, the process illustrated in FIGS. 8 and 9 is implemented by the processor 20 of the data processing device executing a data processing program. For example, FIGS. 8 and 9 illustrate an example of the forward process in the method of generating a neural network model by machine learning. For substantially the same process as in FIG. 6, the same step number is attached, and detailed description will be omitted.

The process from Step S10 to Step S18 is substantially the same as the process from Step S10 to Step S18 in FIG. 6. However, after Step S16 and Step S18, the process transitions to Step S19 instead of Step S20.

At Step S19, the processor 20 refers to the compression determination bits of the determination table TBL2, to determine whether to compress the intermediate data generated by the forward process of the target processing layer. If it is determined to compress the intermediate data, the processor 20 causes the process to transition to Step S20; or if it is determined not to compress the intermediate data, the process transitions to Step S21.

Here, the determination of whether to compress the data may be determined in accordance with the hardware configuration of the data processing device 100 and the configuration of the neural network. For example, the hardware configuration may be represented by the storage capacity and the memory bandwidth of the SRAM 40, the storage capacity and the memory bandwidth of the DRAM 50, and the processing performances of the arithmetic/logic unit 30. For example, the configuration of the neural network may be represented by the calculation steps of the neural network, or may be represented by a computational graph expressing the neural network.

The process at Step S20 is substantially the same as the process Step S20 in FIG. 6. Note that as in the embodiment described above, the data processing device 100 may convert the generated intermediate data from double-precision floating-point number data to single-precision floating-point number data, to compress the intermediate data. The data processing device 100 may convert single-precision floating-point number data to 8-bit fixed-point number data, to compress the intermediate data. Further, the data processing device 100 may compress the intermediate data by reducing the number of bits (the number of digits) in the mantissa of the floating-point number data.

Also, the compression rate of the intermediate data may be set higher as training of the neural network progresses. The data processing device 100 may compress multiple items of intermediate data together, instead of compressing the items of intermediate data one by one.

After Step S20, the process transitions to Step S22 in FIG. 9. At Step S21, the processor 20 refers to the transfer determination bits of the determination table TBL2. If the transfer determination bits are ‘00’, the processor 20 causes the process to transition to Step S28 in FIG. 9, or if the transfer determination bits are ‘01’, causes the process transitions to Step S30 in FIG. 9.

The process from Step S22 to Step S30 in FIG. 9 is substantially the same as the process from Step S22 to Step S30 in FIG. 6. However, the process at Step S28 is also executed if it is determined at Step 21 in FIG. 8 that the intermediate data is to be transferred to the DRAM 50. The process at Step S30 is also executed if it is determined at Step 21 in FIG. 8 that the intermediate data is not to be transferred to the DRAM 50.

As above, in the embodiment described with FIGS. 7 to 9, the same effects as in the embodiment described above can be obtained. For example, by compressing the intermediate data, and then, holding the data in the memory, the memory usage can be reduced, and the transfer time of the intermediate data can be reduced. Accordingly, the memory bandwidth for transferring the intermediate data can be curbed, and increase in the system cost of the data processing device 100 can be curbed.

Further, in this embodiment, by providing the compression determination bit in the determination table TBL2, the data processing device 100 can switch between compression and non-compression of the intermediate data for each target processing layer. Accordingly, in the case where the size of the intermediate data is large, increase in the memory bandwidth can be curbed, and increase in the system cost of the data processing device can be curbed. On the other hand, in the case where the size of the intermediate data is small, the compression cost can be reduced.

By changing the meaning of the transfer determination bits depending on compression or non-compression of the intermediate data according to the compression determination bit, the transfer determination bits can be shared between the case of compressing the intermediate data and the case of not compressing the intermediate data, and thereby, increase in the size of the determination table TBL2 can be curbed.

Part of or all of the data processing device in the embodiments described above may be configured by hardware or by information processing by software (program) running on a CPU (Central Processing Unit) or a GPU (Graphics Processing Unit). In the case of being configured by information processing by software, software that implements at least part of the functions of the devices in the embodiments described above, may be stored in a non-transitory storage medium (non-transitory computer-readable medium) such as a flexible disk, CD-ROM (Compact Disc-Read Only Memory), or USB (Universal Serial Bus) memory, to execute information processing by the software by loading the software on a computer. Also, the software may be downloaded via a communication network. Further, the information processing may be executed by hardware by having the software implemented in a circuit such as an ASIC (Application Specific Integrated Circuit) or FPGA (Field Programmable Gate Array).

The type of storage medium including software such as the data processing program is not limited. The storage medium is not limited to one that is attachable and detachable such as a magnetic disk or an optical disk, and may be a fixed type storage medium such as a hard disk or a memory. Also, a storage medium may be provided in a computer or outside a computer.

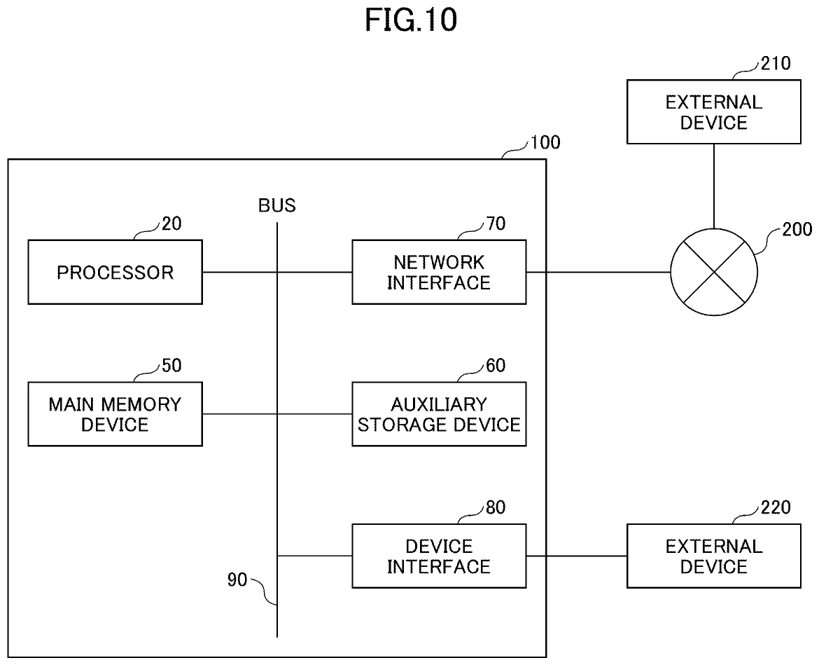

FIG. 10 is a block diagram illustrating an example of a hardware configuration of the data processing device according to the embodiment described above. In the following, the hardware configuration of the data processing device 100 in FIG. 1 will be described. The data processing device 100 may be implemented, for example, as a computer that includes a processor 20, a main memory device 50 (e.g., a DRAM 50), an auxiliary storage device 60 (memory), a network interface 70, and a device interface 80, and these devices are connected through a bus 90. For example, the operations described in FIG. 6 or FIGS. 8 and 9 are executed by the processor 20 executing the data processing program.

Although the data processing device 100 is provided with one instance of each component, the data processing device 100 may be provided with multiple instances of each component. Also, in FIG. 10, although one unit of the data processing device 100 is illustrated, the software may be installed in multiple data processing devices 100, to have the multiple data processing devices 100 execute part of processes of the software that may be the same or different from one another. In this case, a form of distributed computing may be adopted in which the data processing devices 100 communicate with one another through the network interface 70 or the like to execute processing. In other words, the data processing device 100 in the embodiment described above may be configured as a computer system that implements functions by one unit or multiple units of the data processing devices 100 executing instructions stored in one or more storage devices. Also, alternative configuration may be adopted in which information transmitted from a terminal is processed by one unit or multiple units of the data processing devices 100 provided on a cloud, and processed results are transmitted to the terminal.

The operations described with the flow in FIG. 6 and the operations described in the flow in FIGS. 8 and 9 may be executed by parallel processing using one or more processors 20, or using multiple computers communicating with one another through a network. Also, various operations may be allotted to multiple arithmetic/logic cores provided in the processor 20, to be executed by parallel processing. Some or all of the processes, means, and the like in the present disclosure may be executed by at least one of processors and storage devices provided on a cloud that can communicate with the data processing device 100 through a network. In this way, the data processing device 100 in the embodiment described above may have a configuration of parallel computing performed by one or more computers.

The processor 20 may be an electronic circuit that includes a control device and an arithmetic/logic device of a computer (a processing circuit, processing circuitry, CPU, GPU, FPGA, ASIC, etc.). Also, the processor 20 may be a semiconductor device or the like that includes a dedicated processing circuit. The processor 20 is not limited to an electronic circuit using electronic logic elements, and may be implemented by an optical circuit using optical logic elements. Also, the processor 20 may include a computing function based on quantum computing.

The processor 20 may execute operations based on data input from devices as internal components of the data processing device 100 and software (program), and may output results of the operations and control signals to the respective devices and the like. The processor 20 may execute an OS (Operating System), an application, and the like of the data processing device 100, to control the respective components that constitute the data processing device 100.

The data processing device 100 according to the embodiments described above may be implemented by one or more processors 20. Here, the processor 20 may correspond to one or more integrated circuits arranged on one chip, or may correspond to one or more integrated circuits arranged on two or more chips or two or more devices. In the case of using multiple integrated circuits, the integrated circuits may communicate with each other by wire or wirelessly.

The main memory device 50 (e.g., the DRAM 50 in FIG. 1) may store instructions to be executed by the processor 20 and various items of data, and information stored in the main memory device 50 may be read by the processor 20. The auxiliary storage device 60 may be a storage device other than the main memory device 50. Note that these storage devices may correspond to any electronic component that can store electronic information, and may be a semiconductor memory. The semiconductor memory may be either a volatile memory or a non-volatile memory. The storage device that stores various items of data in the data processing device 100 in the embodiment described above may be implemented by the main memory device 50 or the auxiliary storage device 60, or may be implemented by the SRAM 40 or the like built in the processor 20.

In the case where the data processing device 100 in the embodiments described above includes at least one storage device (memory) and multiple processors 20 connected (coupled) with at least this one storage device, with one storage device, multiple processors 20 may be connected (coupled), or one processor 20 may be connected (coupled). Also, with one processor 20, multiple storage devices (memories) may be connected (coupled), or one storage device (memory) may be connected (coupled). Also, a configuration in which at least one processor 20 from among multiple processors 20 is connected (coupled) with at least one storage device (memory), may be included. Also, this configuration may be implemented with storage devices (memories) and processors 20 included in multiple data processing devices 100. Further, a configuration in which the storage device (memory) is integrated with a processor 20 (e.g., a cache memory including an L1 cache and an L2 cache) may be included.

The network interface 70 is an interface to establish connection to a communication network 200 wirelessly or by wire. For the network interface 70, an appropriate interface such as an interface that conforms to an existing communication standard, may be used. Various types of data may be exchanged by the network interface 70 with an external device 210 connected through the communication network 200. Note that the communication network 200 may be any one or a combination of a WAN (Wide Area Network), a LAN (Local Area Network), a PAN (Personal Area Network), and the like, as long as the network is used to exchange information between the data processing device 100 and the external device 210. One example of WAN is the Internet, one example of LAN is IEEE 802.11 and Ethernet (registered trademark), and one example of PAN is Bluetooth (registered trademark) and near field communication (NFC).

The device interface 80 is an interface that is directly connected with an external device 220, such as USB.

The external device 220 may be connected to the data processing device 100 via a network, or may be directly connected to the data processing device 100.

The external device 210 or the external device 220 may be, for example, an input device. The input device may be, for example, a camera, a microphone, a motion capture, various sensors, a keyboard, a mouse, or a touch panel or the like, and provides obtained information to the data processing device 100. Alternatively, the input device may be, for example, a device that includes an input unit, a memory, and a processor, such as a personal computer, a tablet terminal, or a smartphone.

Alternatively, the external device 210 or the external device 220 may be, for example, an output device. The output device may be, for example, a display device such as an LCD (Liquid Crystal Display), a CRT (Cathode Ray Tube), a PDP (Plasma Display Panel), or an organic EL (Electro Luminescence) panel, or may be a speaker that outputs voice and the like. Alternatively, it may also be a device including an output unit, a memory, and a processor, such as a personal computer, a tablet terminal, or smartphone.

Also, the external device 210 or the external device 220 may be a storage device (i.e., a memory). For example, the external device 210 may be a storage device such as a network storage, and the external device 220 may be a storage device such as an HDD. The external device 220 as a storage device (memory) is an example of a recording medium that is readable by a computer such as the processor 20.

The external device 210 or the external device 220 may be a device having some of the functions of the components of the data processing device 100. In other words, the data processing device 100 may transmit or receive part of or all of results of processing executed by the external device 210 or the external device 220.

In the present specification (including the claims), in the case of using an expression (including any similar expression) “at least one of a, b, and c” or “at least one of a, b, or c”, any one of a, b, c, a-b, a-c, b-c, or a-b-c is included. Multiple instances may also be included in any of the elements, such as a-a, a-b-b, and a-a-b-b-c-c. Further, addition of another element other than the listed elements (i.e., a, b, and c), such as adding d as a-b-c-d, is included.

In the present specification (including the claims), in the case of using an expression such as “data as an input”, “using data”, “based on data”, “according to data”, or “in accordance with data” (including similar expressions), unless otherwise noted, a case in which various items of data itself is used as an input, and a case in which data obtained by processing various items of data (e.g., data obtained by adding noise, normalized data, a feature value extracted from data, and intermediate representation of various items of data) is used as an input, are included. Also, in the case where it is described that any result can be obtained “based on data”, “using data”, “according to data”, or “in accordance with data” (including similar expressions), a case in which the result is obtained based on only the data is included, and a case in which the result is obtained affected by data other than the data, factors, conditions, and/or states may be included. In the case where it is described that “data is output” (including similar expressions), unless otherwise noted, a case in which various items of data itself is used as an output, and a case in which data obtained by processing various items of data in some way (e.g., data obtained by adding noise, normalized data, a feature value extracted from data, and intermediate representation of various items of data) is used as an output, are included.

In the present specification (including the claims), in the case where terms “connected” and “coupled” are used, the terms are intended as non-limiting terms that include any of direct connection/coupling, indirect connection/coupling, electric connection/coupling, communicative connection/coupling, operative connection/coupling, and physical connection/coupling. Such a term should be interpreted according to a context in which the term is used, but a connected/coupled form that is not intentionally or naturally excluded should be interpreted as being included in the terms without being limited.

In the present specification (including the claims), in the case where an expression “A configured to B” is used, the meaning includes that a physical structure of an element A has a configuration that can execute an operation B, and that a permanent or temporary setting/configuration of the element A is configured/set to actually execute the operation B. For example, in the case where the element A is a general purpose processor, the processor may have a hardware configuration that can execute the operation B and be configured to actually execute the operation B by setting a permanent or temporary program (i.e., an instruction). Also, in the case where the element A is a dedicated processor or a dedicated arithmetic/logic circuit, the circuit structure of the processor may be implemented so as to actually execute the operation B irrespective of whether control instructions and data are actually attached.

In the case where a term indicating containing or possessing (e.g., “comprising/including” and “having”) is used, the term is intended as an open-ended term, including an inclusion or possession of an object other than a target object indicated by the object of the term. In the case where the object of the term indicating an inclusion or possession is an expression that does not specify a quantity or that suggests a singular number (i.e., an expression using “a” or “an” as an article), the expression should be interpreted as being not limited to a specific number.

In the present specification (including the claims), even if an expression such as “one or more” or “at least one” is used in a certain passage, and an expression that does not specify a quantity or that suggests a singular number (i.e., an expression using “a” or “an” as an article) is used in another passage, it is not intended that the latter expression indicates “one”. In general, an expression that does not specify a quantity or that suggests a singular number (i.e., an expression using “a” or “an” as an article) should be interpreted as being not necessarily limited to a particular number.

In the present specification, in the case where it is described that a particular effect (advantage/result) is obtained in a particular configuration included in an embodiment, unless there is a particular reason, it should be understood that that the effect can be obtained in one or more different embodiments having the configuration. It should be understood, however, that the presence or absence of the effect generally depends on various factors, conditions, states, and/or the like, and that the effect is not necessarily obtained by the configuration. The effect is merely to be obtained from the configuration described in the embodiment when various factors, conditions, states, and/or the like are satisfied, and is not necessarily obtained in the claimed invention that defines the configuration or a similar configuration.

In the present specification (including the claims), in the case of using a term such as “maximization (maximize)”, the meaning of the term includes determining a global maximum value, determining an approximate value of a global maximum value, determining a local maximum value, and determining an approximate value of a local maximum value, and the term should be interpreted as appropriate, depending on the context in which the term is used. The meaning also includes determining an approximate value of such a maximum value stochastically or heuristically. Similarly, in the case of using a term such as “minimization (minimize)”, the meaning of the term includes determining a global minimum value, determining an approximate value of a global minimum value, determining a local minimum value, and determining an approximate value of a local minimum value, and the term should be interpreted as appropriate, depending on the context in which the term is used. The meaning also includes determining an approximate value of such a minimum value stochastically or heuristically. Similarly, in the case of using a term such as “optimization (optimize)”, the meaning of the term includes determining a global optimum value, determining an approximate value of a global optimum value, determining a local optimum value, and determining an approximate value of a local optimum value, and the term should be interpreted as appropriate, depending on the context in which the term is used

The meaning also includes determining an approximate value of such an optimal value stochastically or heuristically.

In the present specification (including the claims), in the case where multiple hardware components executes predetermined processes, each of the hardware components may interoperate to execute the predetermined processes, or some of the hardware components may execute all of the predetermined processes. Alternatively, some of the hardware components may execute some of the predetermined processes while the other hardware components may execute the rest of the predetermined processes. In the present specification (including the claims), in the case where an expression such as “one or more hardware components execute a first calculation process and the one or more hardware components execute a second calculation process” is used, the hardware component that executes the first calculation process may be the same as or different from the hardware component that executes the second calculation process. In other words, the hardware component that executes the first calculation process and the hardware component that executes the second calculation process may be included in the one or more hardware components. The hardware component may include an electronic circuit, a device including an electronic circuit, and the like.

In the present specification (including the claims), in the case where multiple storage devices (memories) store data, each of the multiple storage devices (memories) may store only part of the data or may store the entirety of the data. Further, a configuration may be adopted in which some of the multiple storage devices (memories) stores data.

As above, the embodiments of the present disclosure have been described in detail; note that the present disclosure is not limited to the individual embodiments described above. Various additions, modifications, substitutions, partial deletions, and the like may be made without departing from the conceptual idea and gist of the invention derived from the contents defined in the claims and the equivalents thereof. For example, in all of the embodiments described above, numerical values or mathematical expressions used for description are presented as an example and are not limited thereto. Additionally, the order of operations in the embodiments is presented as an example and is not limited thereto.

What is claimed is:

1. A method for processing data comprising:
compressing data in a course of calculation of a first calculation process, to generate compressed data;
storing the generated compressed data in a memory area; and
executing a second calculation process by using the compressed data stored in the memory area,
wherein the first calculation process is a forward process of a neural network, and
wherein the second calculation process is a backward process of the neural network.

2. The method as claimed in claim 1, further comprising:
generating the data in the course of calculation of the first calculation process, for each layer of a plurality of layers configuring the neural network; and
determining whether to compress the data in the course of calculation, for said each layer of the plurality of layers.

3. The method as claimed in claim 2, wherein the memory area includes a first memory area and a second memory area,
wherein the first memory area is allocated in a first memory,
wherein the second memory area is allocated in a second memory, and
wherein a memory bandwidth of the first memory is greater than a memory bandwidth of the second memory.

4. The method as claimed in claim 3, further comprising:
storing, in the first memory area, while being uncompressed, the data in the course of calculation generated with said each layer of the plurality of layers,
wherein one of the plurality of layers executes the first calculation process by using the uncompressed data in the course of calculation of the first calculation process executed by another layer, that has been stored in the first memory area.

5. The method as claimed in claim 4, further comprising:
holding, for said each layer of the plurality of layers, deletion information indicating whether to delete the uncompressed data calculated by said another layer used in the first calculation process from the first memory, and determining whether to delete the uncompressed data calculated by said another layer from the first memory based on the deletion information.

6. The method as claimed in claim 3, further comprising:
for said each layer of the plurality of layers, holding destination information indicating a storage destination of the generated data in the course of calculation; and
in a case of compressing the data in the course of calculation, based on the destination information, determining whether to store the compressed data in the course of calculation in either one of the first memory area or in the second memory area.

7. The method as claimed in claim 6, further comprising:
in the case of compressing the data in the course of calculation, based on the destination information, further determining whether to store the compressed data in the course of calculation in both the first memory area and the second memory area; and
in a case of not compressing the data, based on the destination information, determining whether to store the compressed data in the course of calculation in the second memory area.

8. The method as claimed in claim 2, further comprising:
determining whether to compress the data in the course of calculation, for said each layer of the plurality of layers, based on calculation steps of the neural network and a configuration of hardware to execute the first calculation process and the second calculation process.

9. The method as claimed in claim 1, further comprising:
generating the compressed data by applying lossy compression to the data in the course of calculation.

10. The method as claimed in claim 9, wherein the data in the course of calculation is floating-point number data, and
wherein the compressed data is generated by reducing a number of bits in a mantissa of the data in the course of calculation.

11. The method as claimed in claim 9, further comprising:
updating, by the second calculation process, parameters used in the first calculation process; and
executing repeatedly a plurality of third calculation processes each including the first calculation process and the second calculation process, while gradually increasing a compression rate of the data.

12. A data processing device comprising:
at least one memory; and
at least one processor configured to:
compress data in a course of calculation of a first calculation process, to generate compressed data;
store the generated compressed data in a memory area; and
execute a second calculation process by using the compressed data stored in the memory area,
wherein the first calculation process is a forward process of a neural network, and
wherein the second calculation process is a backward process of the neural network.

13. The data processing device as claimed in claim 12, wherein the at least one processor is configured to generate the data in the course of calculation of the first calculation process, for each layer of a plurality of layers configuring the neural network and determine whether to compress the data in the course of calculation, for said each layer of the plurality of layers.

14. The data processing device as claimed in claim 13, wherein the memory area includes a first memory area and a second memory area,
wherein the first memory area is allocated in a first memory included in the at least one memory,
wherein the second memory area is allocated in a second memory included in the at least one memory, and
wherein a memory bandwidth of the first memory is greater than a memory bandwidth of the second memory.

15. The data processing device as claimed in claim 14, wherein the at least one processor is configured to store, in the first memory area, while being uncompressed, the data in the course of calculation generated with said each layer of the plurality of layers,
wherein one of the plurality of layers executes the first calculation process by using the uncompressed data in the course of calculation of the first calculation process executed by another layer, that has been stored in the first memory area.

16. The data processing device as claimed in claim 15, wherein the at least one processor is configured to hold, for said each layer of the plurality of layers, deletion information indicating whether to delete the uncompressed data calculated by said another layer used in the first calculation process from the first memory, and determine whether to delete the uncompressed data calculated by said another layer from the first memory based on the deletion information information.

17. The data processing device as claimed in claim 14, wherein the at least one processor is configured to, for said each layer of the plurality of layers, hold destination information indicating a storage destination of the generated data in the course of calculation, and in a case of compressing the data in the course of calculation, based on the destination information, determine whether to store the compressed data in the course of calculation in either one of the first memory area or in the second memory area.

18. The data processing device as claimed in claim 17, wherein the at least one processor is configured to, in the case of compressing the data in the course of calculation, based on the destination information, further determine whether to store the compressed data in the course of calculation in both the first memory area and the second memory area; and
in a case of not compressing the data, based on the destination information, determine whether to store the compressed data in the course of calculation in the second memory area.

19. The data processing device as claimed in claim 13, wherein the at least one processor is configured to determine whether to compress the data in the course of calculation, for said each layer of the plurality of layers, based on calculation steps of the neural network and a configuration of hardware to execute the first calculation process and the second calculation process.

20. The data processing device as claimed in claim 12, wherein the at least one processor is configured to generate the compressed data by applying lossy compression to the data in the course of calculation.
